(19) United States
(12) Patent Application Publication
(10) Pub. No.: US 2025/0073726 A1
(43) Pub. Date: Mar. 6, 2025

(54) DEVICE AND METHOD FOR SHREDDING OBJECTS

(71) Applicants: Novo-Tech GmbH & Co. KG, Aschersleben (DE); TAKRAF GmbH, Leipzig (DE)

(72) Inventors: Holger SASSE, Aschersleben (DE); Marko SCHMIDT, Hoyerswerda (DE); Marcus MEINEL, Brieske (DE); Matthias GNILKE, Lauchhammer (DE)

(73) Assignees: Novo-Tech GmbH & Co. KG, Aschersleben (DE); TAKRAF GmbH, Leipzig (DE)

(21) Appl. No.: 18/728,552

(22) PCT Filed: Jan. 13, 2023
(86) PCT No.: PCT/EP2023/050757

§ 371 Date: Jul. 12, 2024

(30) Foreign Application Priority Data
Jan. 14, 2022 (DE) 10 2022 100 857.6

(51) Int. Cl. B02C 18/22; B02C 18/14

(52) U.S. Cl. CPC B02C 18/2233; B02C 18/142

(57) ABSTRACT

A device for shredding objects includes a feed tray for the reception of objects to be shredded, a roller shredder with at least one powered roller and a further working means in the form of a roller or a comb-shaped counterpart, between which a working gap is formed, in order to shred objects from the feed tray and convey them through the working gap, and a pushing element which can be moved in the feed tray and by means of which the objects to be shredded can be conveyed to the roller shredder. The feed tray can be closed on an upside by a removable cover and an interior space of the feed tray is connected to a suction device for producing a negative pressure.

The present invention relates to a device for shredding objects, including a feed tray for the reception of objects to be shredded, a roller shredder with at least one powered roller and a further working means in the form of a roller or a comb-shaped counterpart, between which a working gap is formed in order to shred objects from the feed tray and convey them through the working gap, and a pushing element movable in the feed tray, by means of which the objects to be shredded can be conveyed to the roller shredder, the feed tray being closable at an upside by a removable cover, and a method for shredding objects.

DE 10 2019 120 291 A1 discloses a shredding machine for shredding mineral or non-mineral material, in which two rollers are rotatable about a horizontal axis in order to shred the bulk material coming from above. Such an arrangement of rollers is suitable for shredding bulk material. However, the problem consists of the fact that longer objects and waste materials with fibre-reinforced plastics in particular are difficult to shred with this shredding machine.

CN 201 720 101 U discloses a shredding device for medical waste that can be fed into a pressing chamber via a feed chute that can be closed by a flap. In the pressing chamber, a pressure element can press the medical waste towards a shredding roller.

CN 205 550 458 U discloses a shredding device for textile waste and plastics with a displaceable pressure piece and a roller shredder. The pressing chamber can be closed via a pivotable flap.

It is therefore the problem to be solved by the present invention to provide a device and a method for shredding objects, which can effectively shred objects with different geometries and made of different materials.

This problem is solved by a device with the features of claim 1 and a method with the features of claim 11.

According to the invention, the device for shredding objects includes a pushing element which is moveable in a feed tray, by means of which pushing element the objects to be shredded can be conveyed to a roller shredder, wherein the feed tray is closable on one upside by a removable cover. This allows the objects to be filled into the feed tray from above via a large filling opening. This means that long objects, for example elongate waste materials made of fibre-reinforced plastics, such as cut-off rotor blades from windmills, can also be easily filled into the feed tray. After filling, the removable cover can then be placed on the feed tray. The objects can then be conveyed to the roller shredder via the pushing element, where high forces of one or several tonnes of pushing force can be applied via the pushing element so that the objects are reliably conveyed to the roller shredder by the pressure and shredded there. In the case of fibre-reinforced plastics in particular, objects with high strength can also be shredded.

To avoid contamination of the ambient air when shredding the objects, a suction system is provided according to the invention, which creates a negative pressure in the interior space when shredding the objects. This allows particularly fibre-reinforced plastics to be shredded effectively, while preventing fibres and other fine particles from escaping via the suction with a connected filter system.

Preferably, an interior space of the feed tray is enclosed in a closed position by the pushing element, the cover and the roller shredder. The feed tray can here be formed essentially channel-shaped with a floor and two side walls, which are closed on the upside by the cover. The removable cover can either be placed on the feed tray or mounted by a guide, for example pivotable or displaceable.

The cover can be formed in a single or multiple parts and be plate-shaped, curved or hood-shaped. The floor of the feed tray is preferably oriented essentially horizontal, so that gravity has no influence on the conveying of the material to be shredded.

Preferably, the suction for creating a negative pressure comprises a volume flow of at least 5 m³ per second, for example between 10 m³ per second and 100 m³ per second.

In a preferred embodiment, the interior space of the feed tray in an initial position of the pushing element has a volume of at least 30 m^{3,} in particular between 50 m³ and 200 m³, so that even large elongate objects, for example with a length of between 4 m and 8 m, can be effectively shredded.

The pushing element preferably comprises a pressure plate that is arranged perpendicular to a longitudinal direction of the channel-shaped feed tray. The objects can then be conveyed to the roller shredder via the pressure plate, whereby the pushing element is guided along the feed tray via a roller or sliding guide.

For effective filling of the feed tray, the pushing element preferably comprises a tilting device on one upside with which a container can be pivotable. The tilting device may, for example, comprise a frame pivotable about a horizontal axis, to which a container or an adaptor fixed to the container can be locked. This allows the frame to be pivotable relative to the pushing element arranged in the feed tray via a drive. Preferably, the tilting device is held movably in the feed tray together with the pushing element, so that the container arranged on the pushing element can also be moved during the filling process. The container is preferably closed at one end by doors, which are opened to fill the feed tray so that the objects can be poured into the feed tray via the side opening on the container.

The working gap between the roller and the further working means of the roller crusher is preferably oriented horizontally, so that the roller and the further working means are arranged one above the other in a vertical direction. Alternatively, it is possible to rotate the rollers with a vertical axis and align the working gap vertically. The further working means can be formed in the form of a roller or a comb-shaped counterpart. Each roller can be formed from one or more rotatable rotating parts. The comb-shaped counterpart is stationary or adjustable.

To apply high compressive forces to the objects in the feed tray, a hydraulic drive is preferably provided, by means of which the pushing element can be moved. Via the hydraulic drive, the pushing element can be moved, for example by at least 5 metres, for example, between 8 and 15 metres.

The cover is preferably placed in a sealed manner on one edge of the feed tray. Here, the cover can optionally also be locked to the feed tray so that the cover cannot be lifted from the feed tray when the objects are being shredded. The cover can be made of a sheet steel in order to be able to absorb higher forces if objects are pressed against the cover from below. The sheet steel of the cover can be reinforced by a corrugated shape. The cover can rest on one edge of the channel and be locked there to prevent it from being lifted. Several openings are preferably provided in the area of the edge of the channel to draw in air during the shredding process.

In the method according to the invention for shredding objects, the objects are filled from above via a filling opening into a feed tray, on which a roller shredder is arranged on one side and a pushing element is arranged on the opposite side. After filling, the filling opening on the upside of the feed tray is closed with a cover, in particular closed in a substantially sealed manner. The objects in the feed tray are then shredded by the roller shredder, with the pushing element being moved in a pushing direction towards the roller shredder in order to feed the objects in the feed tray to the roller shredder. This allows high compressive forces to be applied to the objects, for example of one or more tonnes, so that even long or solid objects can be shredded effectively. After shredding the objects in the feed tray, the pushing element is moved back to an initial position and the cover on the upside of the feed tray is removed so that the filling opening is now available again for the next filling process. This means that large-volume objects in particular, such as cut-off rotor blades or other elongate objects made of fibre-reinforced plastics from the automotive sector or other applications, can be shredded.

To prevent contamination of the air outside the feed tray, according to the invention a negative pressure is generated in the feed tray by a suction system during the shredding of objects, so that air from the feed tray is sucked in via the suction system and then cleaned in a filtration means.

The pushing element preferably includes a tilting device, and objects are filled into the feed tray by tilting a container on the pushing element. The pushing element can preferably be moved against the pushing direction during the tilting and filling of objects, so that the objects are distributed in the feed tray by the movement of the pushing element. The tilting and movement of the pushing element can take place simultaneously or alternately and can optionally also be programme-controlled.

The invention is explained in more detail below with reference to the accompanying drawings. It shows:

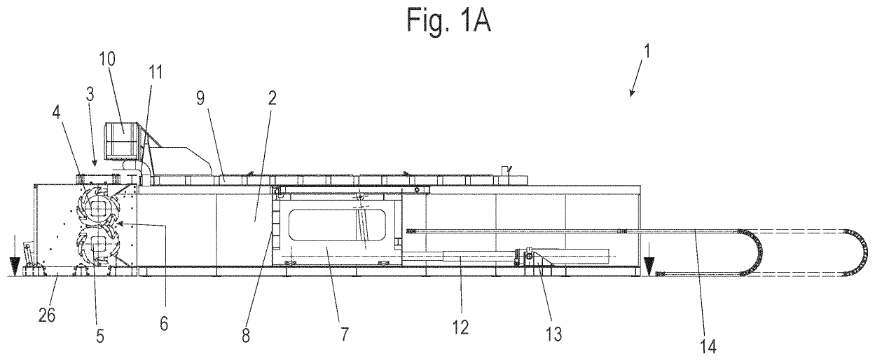

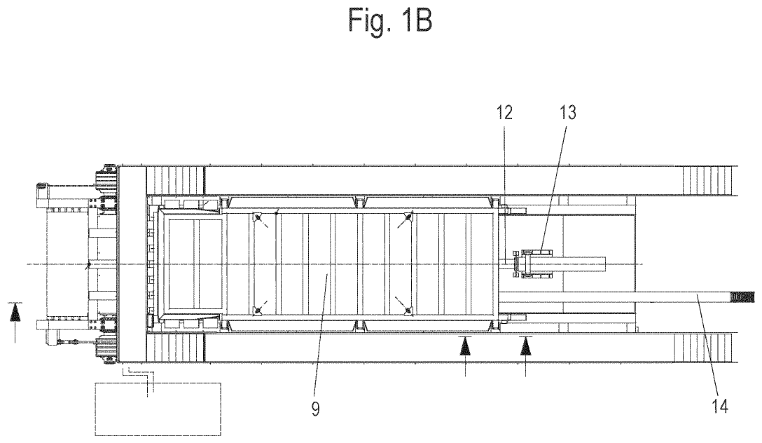

FIGS. 1A and 1B two views of a device for shredding objects according to the invention;

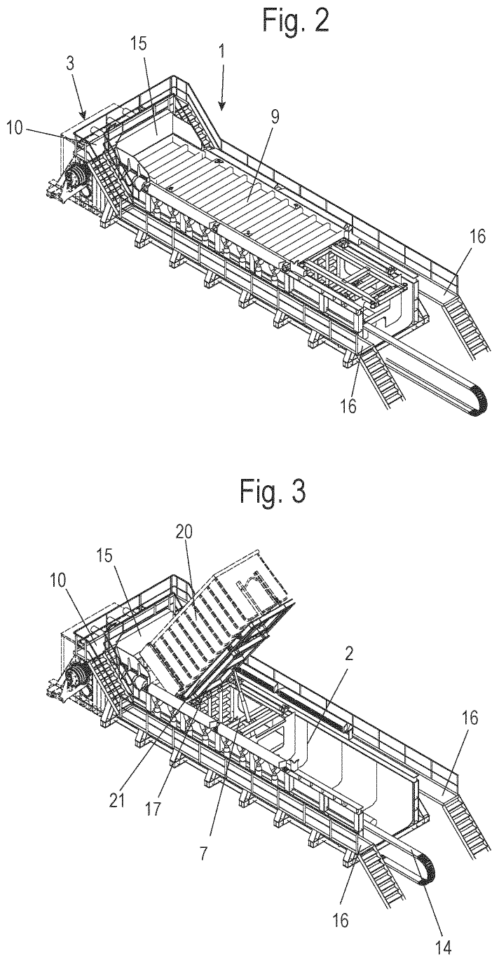

FIG. 2 a perspective view of the device of FIG. 1 in a closed position;

FIG. 3 a perspective view of the device of FIG. 1 during a filling process;

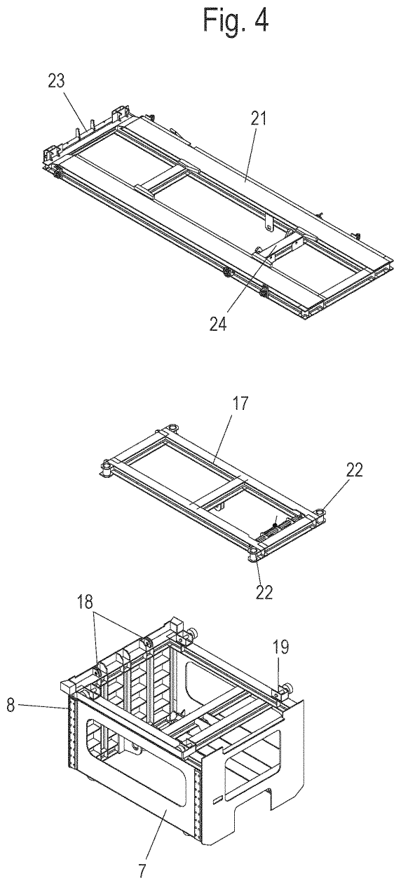

FIG. 4 an exploded view of the pushing element of the device of FIG. 1;

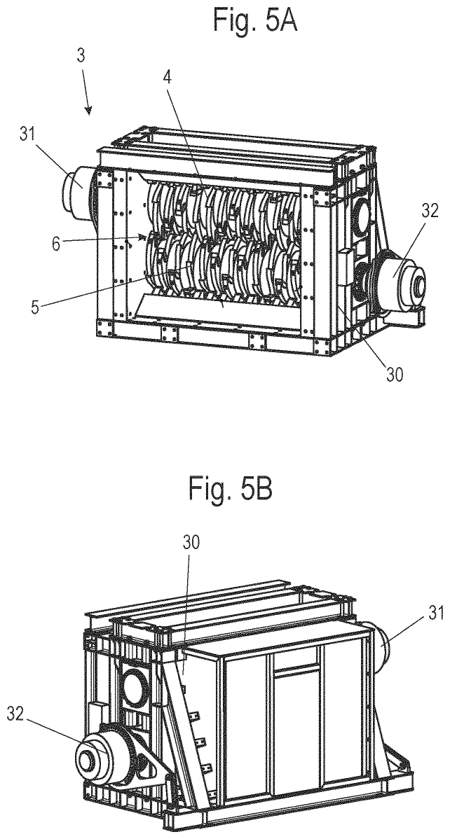

FIGS. 5A and 5B two views of the roller crusher of the device of FIG. 1;

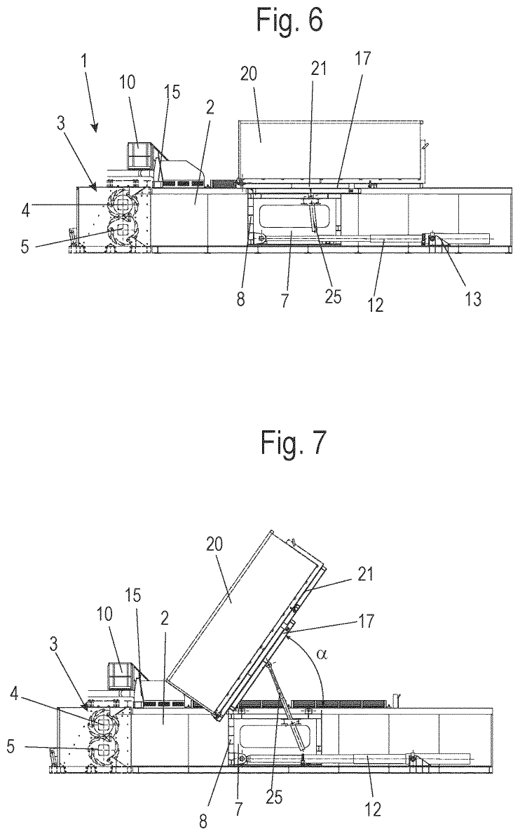

FIG. 6 a view of the device of FIG. 1 before filling;

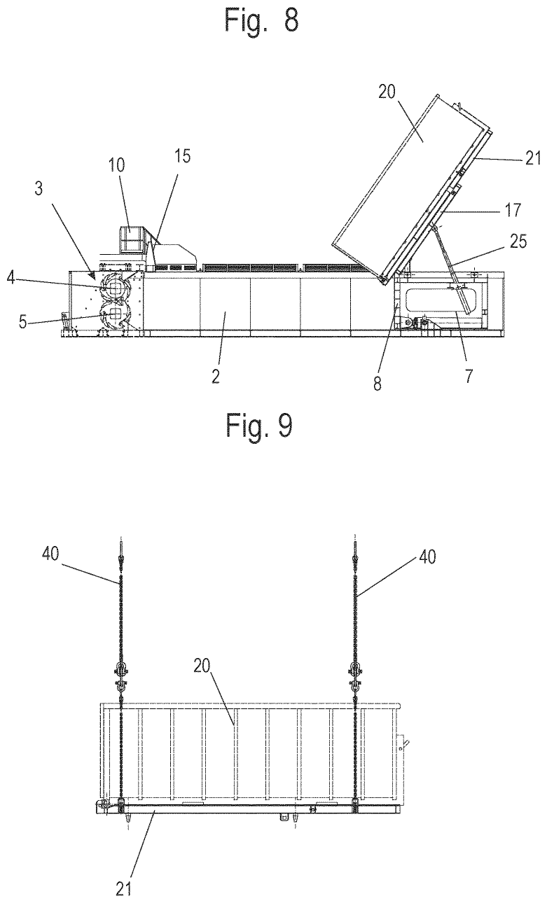

FIGS. 7 and 8 two views of the device of FIG. 6 during the filling process;

FIG. 9 a view of a container before it is placed on the pushing element;

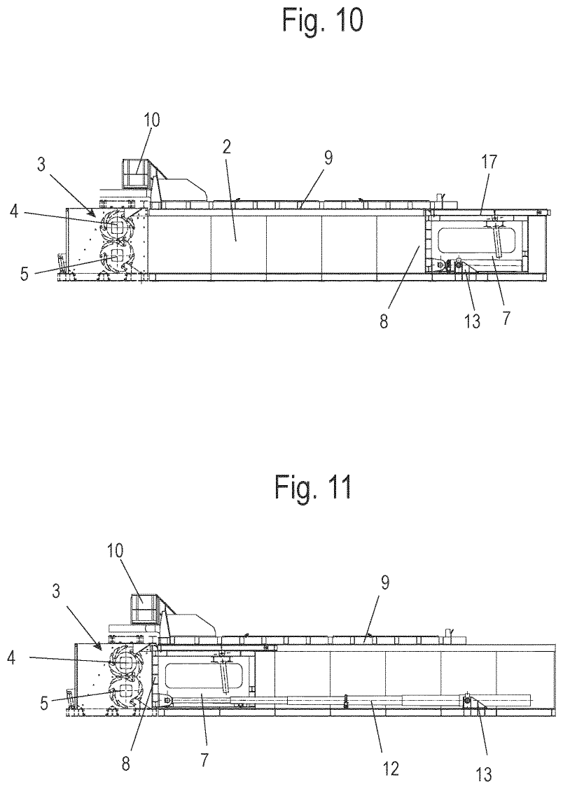

FIG. 10 a view of the device of FIG. 1 in an initial position of the pushing element, and

FIG. 11 a view of the device of FIG. 1 with the pushing element in an end position.

A device 1 for shredding objects includes a feed tray 2 which is formed in a channel-shaped manner and comprises, for example, a length of between 8 and 20 metres. A roller shredder 3 is arranged at one end of the feed tray 2 and comprises an upper powered roller 4 and a lower powered roller 5, between which a horizontal working gap 6 is formed. The objects shredded by the roller shredder 3 can be fed to a container or a pipe behind the roller shredder 3 via an opening 26 at the bottom, in order to collect the shredded objects or convey them to a further device.

A pushing element 7 is movably arranged in the channel-shaped feed tray 2, which comprises a pressure plate 8 on the side facing the roller shredder 3, which has essentially the same width as the distance between the two side walls of the feed tray 2. In addition, the pressure plate 8 comprises approximately the same height as the feed tray 2.

The feed tray 2 can be closed in the area in front of the roller shredder 3 with a removable cover 9, which can be placed on one edge of the feed tray 2. Optionally, the cover 9 can be formed essentially plate-shaped, in particular from a steel sheet, optionally in corrugated form, and can be locked to the feed tray 2 to prevent lifting.

An optionally provided running web 10 is arranged above the roller crusher 3, which runs as a bridge over the feed tray 2.

A suction unit 11 is provided on the feed tray 2, which includes one or more lines and is connected to a suction fan in order to extract air from the interior space of the feed tray 2 during a shredding, i.e. comminution process and generate negative pressure there. The suction 11 is connected to a filter device and prevents contamination of air outside the feed tray 2. Optionally, the suction 11 can be connected to a heat exchanger for heating or cooling ambient air. The air cleaned in the filter device can then be blown outside and replaced by outside air.

A multi-part hydraulic cylinder 12 is provided for the drive of the pushing element 7, which is supported on a holder 13 on a floor of the feed tray. Via the hydraulic drive with the hydraulic cylinder 12, the pushing element 7 can push the objects in the feed tray 2 towards the roller shredder 3, preferably with a pushing force of one or more tonnes. A cable carrier 14 is looped to supply power to the pushing element 7, with cables for the sensors and the hydraulic drives also being provided in the cable carrier.

In FIG. 2, the device 1 for shredding objects is shown in a closed position, in which the cover 9 rests on one edge of the feed tray 2. The openings of the suction 11 are at least partially covered by an edge of the cover 9. It can be seen that a running web 16 is arranged on both sides of the feed tray 2, and these running webs 16 are connected to the running web 10 above the roller shredder 3. The cover 9 is formed as a one-piece plate made of sheet steel. Optionally, however, the cover 9 can also be formed in several parts and be pivotable or displaceable on the feed tray 2 in order to be able to alternate between an open and a closed position. The one-piece cover 9 is removable upwards using a lifting device or a crane.

FIG. 3 shows the device 1 in a filling position. The cover 9 has been removed, and a container 20 is arranged on the pushing element 7, which is in a tilting position. The container 20 comprises one or more doors on the lower end face, which are in the open position, so that objects can be filled from the container 20 into the feed tray 2 from above. In the area above the roller shredder 3, there is an impact plate 15 which prevents objects from falling behind the roller shredder 3.

A tilting device comprising a pivotable frame 17 is provided on the upside of the pushing element 7. The container 20 is fixed to the frame 17 via an adaptor 21 so that the container 20 can be moved from a horizontal position to an inclined position.

FIG. 4 shows an exploded view of the pushing element 7 with the tilting device. The pushing element 7 includes a cuboid pushing frame, to the front of which the pressure plate 8 is fixed. Bearings 18 are provided above the pressure plate 8 for the rotatable mounting of the frame 17, so that the frame 17 is pivotable relative to the pushing element 7. Bars 22 are provided on the frame 17, which can be locked to a locking means 19 of the pushing element 7, so that the frame 17 can be fixed to the pushing element 7.

An adaptor 21 can be locked onto the frame 17, which is formed as an adaptor frame and can be fixed to the frame 17 via a locking mechanism 24. Sliding or pivotable bolts, hooks or other elements can be used as bars. Furthermore, there is a locking mechanism 23 on the adaptor 21 for fixing the doors of the container 20 in an open or closed position.

FIGS. 5A and 5B show the roller shredder 3, which includes two rollers 4 and 5 with a horizontal axis, between which a working gap 6 is formed. The rollers 4 and 5 have a plurality of disc-shaped toothed edges with cutting edges on the outer circumference, in order to shred the objects as they pass through the working gap 6. The distance between the rollers 4 and 5 can preferably be adjusted in order to be able to change the size of the shredded components. The upper roller 4 is powered by a drive 31 and the lower roller 5 is powered by a drive 32, which can be formed as hydraulic motors, for example.

The rollers 4 and 5 are arranged in a housing 30, which is formed open on the side of the feed tray 2. For the rest, the housing 30 is closed and only open at an opening on the base side for conveying the shredded objects.

FIG. 6 shows the device 1 in a starting position before filling. The cover 9 on the feed tray 2 has been removed and a container 20 has been placed on the pushing element 7. The container 20 is fixed on the adaptor 21 and the adaptor 21 is locked to the frame 17. At the end of the container 20 facing the impact plate 15, one or more doors are opened and locked to the container 20 or the adaptor 21.

The tilting device on the pushing element 7 is now actuated for filling, as shown in FIG. 7. A drive 25, in particular a hydraulic drive, swivels the frame 17 relative to the pushing element 7 and thus also the container 20, which is fixed to the frame 17 via the adaptor 21. By swivelling the container 20, its floor forms a sliding surface and the objects can fall down into the feed tray 2 at the front end. An angle α between the horizontal position and the inclined position of the frame 17 can be between 45° and 65°, for example, so that the objects can slide into the feed tray 2. In order to prevent objects from remaining in the container 20, in particular longer objects, the pushing element 7 is moved against the pushing direction while the objects are being filled into the feed tray 2. As a result, the container 20 moves from the front position according to FIG. 7 to an initial position according to FIG. 8, so that it is ensured that the entire contents of the container 20 can be dropped into the feed tray 2. The container 20 can then be swivelled back into the initial position via the tilting device.

In FIG. 9, the container 20 is shown being placed on or removed from the adaptor 21, and the container 20 is located on the adaptor 21. A chain 40 or another traction element is fixed to the container 20 and/or the adaptor 21, by means of which the container 20 can be raised or lowered with the adaptor 21. For example, a crane in a hall or another lifting device can be used as a lifting device.

In FIG. 10, the feed tray 2 is shown in a closed position in which the cover 9 has been placed on an edge of the feed tray 2 so that an interior space of the feed tray 2 is closed at the top. The cover 9 can optionally be locked to the feed tray 2 in order to start shredding the objects. Furthermore, the suction 11 can be switched on and the pushing element 7 is now moved in the pushing direction via the hydraulic cylinder 12. The pushing element 7 is thereby moved from the initial position as shown in FIG. 10 to an end position as shown in FIG. 11, in which the pressure plate 8 is arranged just before the rollers 4 and 5 of the roller shredder 3. The pushing speed of the pushing element 7 can be selected depending on the material to be shredded, preferably at low speeds of between 1 cm and 10 cm per minute. After reaching the end position, the cover 9 can then be removed again in order to place another container 20 with objects on the pushing element 7.

### LIST OF REFERENCE SYMBOLS

1 Device
2 Feed tray
3 Roller shredder
4 Roller
5 Roller
6 Working gap
7 Pushing element
8 Pressure plate
9 Cover
10 Running web
11 Suction
12 Hydraulic cylinder
13 Holder
14 Cable carrier
15 Impact plate
16 Running web
17 Frame
18 Bearing
19 Locking means
20 Container
21 Adaptor
22 Bar
23 Locking mechanism
24 Locking mechanism
25 Drive
26 Opening
30 Housing
31 Drive
32 Drive
40 Chain
α Angle

1. A device (1) for shredding objects, including:
a) a feed tray (2) configured for the reception of objects to be shredded;
b) a roller shredder (3) with at least one powered roller (4) and a further working means in the form of a roller (5) or a comb-shaped counterpart, between which a working gap (6) is formed in order to shred objects from the feed tray (2) and convey them through the working gap (6);
c) a pushing element (7) movable in the feed tray (2), the pushing element being configured to convey objects to be shredded to the roller shredder (3);
d) a removable cover (9) configured for closing the feed tray (2) closed on one upside;
wherein an interior space of the feed tray (2) is connected to a suction (11) for producing negative pressure.

2. The device according to claim 1, wherein an interior space of the feed tray (2) is enclosed in a closed position by the pushing element (7), the cover (9) and the roller shredder (3).

3. The device according to claim 1, wherein the suction (11) comprises a volume flow of at least 5 m³ per second to produce a negative pressure.

4. The device according to claim 2, wherein the interior space in an initial position of the pushing element (7) has a volume of at least 30 m³.

5. The device according to claim 1, wherein the pushing element (7) comprises a pressure plate (8) which is arranged perpendicular to a longitudinal direction of the channel-shaped feed tray (2).

6. The device according to claim 1, wherein the pushing element (7) comprises a tilting device on an upside, with which a container (20) is pivotable.

7. The device according to claim 6, wherein the tilting device comprises a frame (17) which is pivotable about a horizontal axis and to which the container (20) or an adaptor (21) fixed to the container (20) can be locked.

8. The device according to claim 7, wherein the frame (17) is pivotable relative to the pushing element (7) arranged in the feed tray (2) via a drive (25).

9. The device according to claim 1, wherein the working gap (6) of the roller shredder between the roller and the further working means (4, 5) is aligned horizontally and the roller (4) and the further working means are arranged one above the other in the a vertical direction.

10. The device according to claim 1, wherein the pushing element (7) is movable in the channel shaped feed tray (2) via a hydraulic drive.

11. The device according to o claim 1, wherein the cover (9) rests in a sealed manner on one edge of the feed tray (2).

12. A method for shredding objects comprising the following steps:
Filling of objects from above via a filling opening into a feed tray (2), on which a roller shredder (3) is arranged on one side and a pushing element (7) on the opposite side;
Closing the filling opening on an upside of the feed tray (2) with a cover (9);
Shredding the objects by the roller shredder (3) and moving the pushing element (7) in a pushing direction to the roller shredder (3) to feed the objects in the feed tray (2) to the roller shredder (3); and
Returning the pushing element (7) to an initial position and removing the cover (9) on the upside of the feed tray (2),
wherein a negative pressure is generated in the feed tray (2) by a suction (11) during shredding of the objects.

13. The method according to claim 12, wherein the pushing element (7) comprises a tilting device and the filling of objects into the feed tray is effected by tilting a container (20) on the pushing element (7).

14. The method according to claim 13, wherein the pushing element (7) is moved in an opposite direction to the pushing direction during the tilting and filling of objects.

15. The method according to claim 12, wherein the suction (11) is connected to a filtration means and air from the feed tray (2) is sucked in via the suction means and then cleaned in the filtration means.

16. The device according to claim 4, wherein the interior space in the initial position of the pushing element (7) has a volume of between 50 m³ and 200 m³.
